(19) United States
(12) Patent Application Publication
(10) Pub. No.: US 2025/0327439 A1
(43) Pub. Date: Oct. 23, 2025

(54) METHODS AND SYSTEMS FOR HARVESTING ENERGY FROM WIND FLOW

(71) Applicant: The American University in Cairo, Cairo (EG)

(72) Inventors: Mustafa Hani Arafa, Giza (EG); Youssef Wael Mohamed AbdelMoneim, New Cairo (EG)

(21) Appl. No.: 19/184,576

(22) Filed: Apr. 21, 2025

Related U.S. Application Data
(60) Provisional application No. 63/636,305, filed on Apr. 19, 2024.

(51) Int. Cl. F03D 5/00; F03D 9/25; H02K 7/18

(52) U.S. Cl. CPC F03D 5/005; F03D 9/25; H02K 7/1876; F05B 2220/706

(57) ABSTRACT

A system for harvesting energy from wind flow includes a bluff body comprising an elongate member having a non-circular cross-section. The bluff body is configured for creating movement when placed in a wind stream. The system includes a compliant mechanism comprising a translating shuttle coupled to the bluff body for moving in a transverse galloping motion when the bluff body is placed in the wind stream and moves. The system includes a mechanical to electrical energy conversion mechanism coupled to the compliant mechanism for generating electrical energy in response to movement of the translating shuttle.

### PRIORITY CLAIM

This application claims the priority benefit of U.S. Provisional Patent Application Ser. No. 63/636,305 filed Apr. 19, 2024, the disclosure of which is incorporated herein by reference in its entirety.

### TECHNICAL FIELD

The subject matter described herein relates to energy harvesting. More particularly, the subject matter described herein relates to methods and systems for harvesting energy from wind flow.

### BACKGROUND

Conventional wind turbines use winds to turn an electric generator. However, the necessary amount of kinetic energy from the wind to turn the generator requires high wind speeds and/or massive blades. These wind turbines can be cost-prohibitive, inefficient due to the number of parts, and ineffective in environments where wind speed is generally low.

There exists a need for energy harvesters that can extract energy from low wind speeds.

### SUMMARY

An example system for harvesting energy from wind flow includes a bluff body including an elongate member having a non-circular cross-section. The bluff body is configured for creating movement when placed in a wind stream. The system further includes a compliant mechanism comprising a translating shuttle coupled to the bluff body for moving in a transverse galloping motion when the bluff body is placed in the wind stream and moves. The system further includes a mechanical to electrical energy conversion mechanism coupled to the compliant mechanism for generating electrical energy in response to movement of the translating shuttle.

In an aspect of the system described herein, the compliant mechanism includes a Chebyschev straight-line linkage.

In an aspect of the system described herein, the compliant mechanism includes a platform attached to the bluff body, a first leg extending from a first end of the platform, and a second leg extending from a second end of the platform opposite the first end, wherein the first and second legs each comprise at least one flexure joint.

In an aspect of the subject matter described herein, the system includes a base coupled to the first and second legs.

In an aspect of the system described herein, the at least one flexure joint includes a flexure joint on each end of the first and second legs, wherein the platform is coupled to the flexure joints on a first end of the first and second legs, and wherein the base is coupled to the flexure joints on a second end of the first and second legs.

In an aspect of the system described herein, the compliant mechanism is three dimensional (3D) printed.

In an aspect of the system described herein, the mechanical to electrical energy conversion mechanism comprises a magnet attached to the translating shuttle and a stationary coil positioned such that movement of the magnet generates a current in the stationary coil.

In an aspect of the system described herein, the non-circular cross-section of the bluff body includes an arrow shape.

In an aspect of the system described herein, the compliant mechanism is configured for transverse galloping when the bluff body encounters wind speeds less than two meters per second.

In an aspect of the system described herein, the compliant mechanism comprises a polymer.

An example method for harvesting energy from wind flow includes exposing an energy harvester to a wind stream. The energy harvester includes a bluff body including an elongate member having a non-circular cross-section. The bluff body is configured for creating movement when placed in a wind stream. The energy harvester further includes a compliant mechanism including a translating shuttle coupled to the bluff body for moving in a transverse galloping motion when the bluff body is placed in the wind stream and moves. The energy harvester further includes a mechanical to electrical energy conversion mechanism coupled to the compliant mechanism for generating electrical energy in response to movement of the translating shuttle. The method further includes generating electrical energy, by the electrical energy conversion mechanism, in response to movement of the translating shuttle.

In an aspect of the method described herein, the compliant mechanism includes a Chebyschev straight-line linkage.

In an aspect of the method described herein, the compliant mechanism includes a platform attached to the bluff body, a first leg extending from a first end of the platform, and a second leg extending from a second end of the platform opposite the first end, wherein the first and second legs each comprise at least one flexure joint.

In an aspect of the subject matter described herein, the method further includes a base coupled to the first and second legs.

In an aspect of the method described herein, the at least one flexure joint includes a flexure joint on each end of the first and second legs, wherein the platform is coupled to the flexure joints on a first end of the first and second legs, and wherein the base is coupled to the flexure joints on a second end of the first and second legs.

In an aspect of the method described herein, the compliant mechanism is three dimensional (3D) printed.

In an aspect of the method described herein, the mechanical to electrical energy conversion mechanism includes a magnet attached to the translating shuttle and a stationary coil positioned such that movement of the magnet generates a current in the stationary coil.

In an aspect of the method described herein, the non-circular cross-section of the bluff body includes an arrow shape.

In an aspect of the method described herein, the compliant mechanism is configured for transverse galloping when the bluff body encounters wind speeds less than two meters per second.

In an aspect of the method described herein, the compliant mechanism includes a polymer.

### BRIEF DESCRIPTION OF THE DRAWINGS

Exemplary implementations of the subject matter described herein will now be explained with reference to the accompanying drawings, of which:

FIG. 1 is a perspective view of an example system for harvesting energy from wind flow;

FIG. 2 is a rear view of an example system for harvesting energy from wind flow;

FIG. 3 is a side view of an example system for harvesting energy from wind flow;

FIG. 4 is a top view of an example system for harvesting energy from wind flow;

FIG. 5A shows an example system for harvesting energy in a first position;

FIG. 5B shows an example system for harvesting energy in a second position; and

FIG. 6 is a flow chart of an example method for harvesting energy from wind flow.

### DETAILED DESCRIPTION

The subject matter described herein relates to method and systems for harvesting energy from wind flow. The system provides a low-cost device that harvests energy from low-speed winds, such as winds slower than two meters per second. The system includes a bluff body on a compliant mechanism. The compliant mechanism can be three-dimensionally (3D) printed as a single component. In some aspects of the described subject matter, the compliant mechanism and the bluff body can be 3D printed as a single unit. The compliant mechanism is based on a Chebyschev straight-line linkage and pushes a magnetized iron rod through a stationary coil in a linear motion. The system is driven by an incoming wind stream that flows around the bluff body, thereby inducing self-sustained transverse galloping that operates an electromagnetic device. Unlike traditional wind turbines, this device responds to low-velocity wind speeds and contains few mechanical parts, thus minimizing mechanical losses and friction. The use of 3D printing in energy harvesting enables the fabrication of deformable polymer mechanisms with specified dynamic characteristics, including stiffness and natural frequency. The design also offers advantages over conventional cantilever-type energy harvesters including its ability to produce favorable motion patterns needed for the development of low-cost electromagnetic harvesters. The system can provide sustainable energy for various outdoor settings and remote areas, such as wireless sensors for structural health monitoring, agricultural monitoring, and forest fire monitoring.

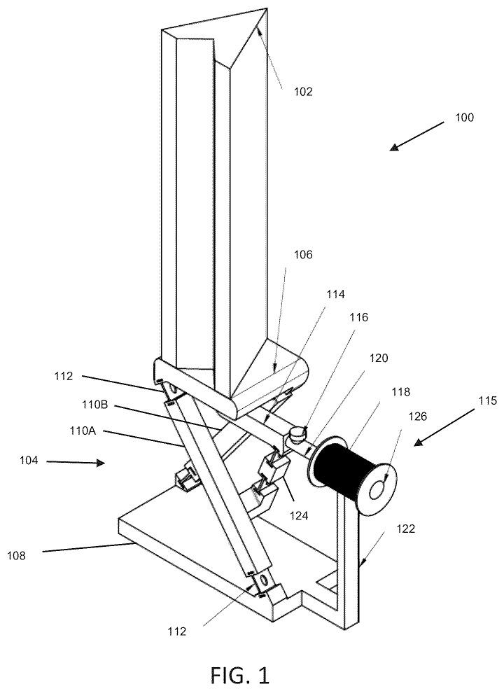

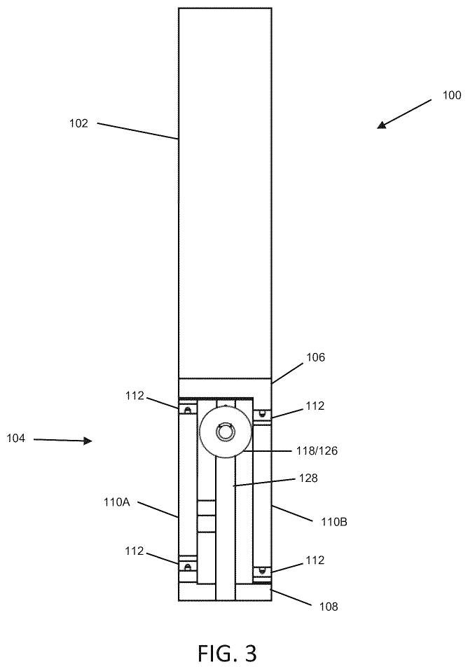

FIGS. 1-4 are a perspective view, a rear view, a side view, and a top view of an example system 100 for harvesting energy from wind flow, respectively. System 100 is an energy harvester and includes a bluff body 102 coupled to a compliant mechanism 104. Bluff body 102 is an elongate member extending from compliant mechanism 104. Bluff body 102 is configured for creating movement when placed in a wind stream. Bluff body 102 can be configured for creating movement when placed in a wind stream that is perpendicular or includes a perpendicular component to a transverse galloping motion of a translating shuttle described herein.

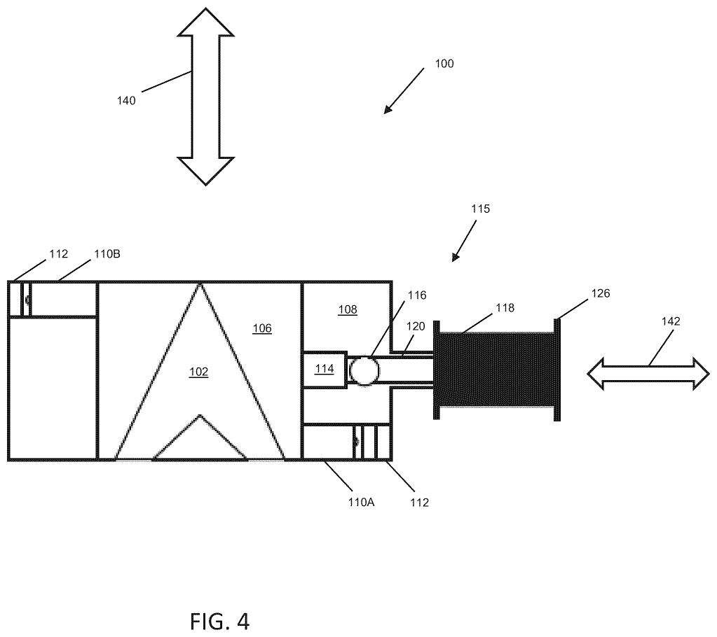

Bluff body 102 can have any suitable shape for creating resistance to and moving laterally when placed in a wind stream. As shown in FIG. 1, bluff body 102 has a non-circular cross-sectional shape, such as an arrow-shaped cross section. It is understood that the cross-sectional shape of bluff body 102 is not limited to the shape shown in FIG. 1 and can include any other shape suitable for catching the wind, ideally from multiple directions. For example, the cross-section shape can be triangular, rectangular, or having any suitable polygonal shape for catching the wind. The cross-sectional shape of bluff body 102 is also shown in the top view of system 100 in FIG. 4.

Compliant mechanism 104 can include a platform 106 coupled to and spaced from a base 108 by legs 110 therebetween. When compliant mechanism 104 is in a resting state, platform 106 can be oriented parallel or substantially parallel to base 108. System 100 can include flexure joints 112, which extend between bodies of the system 100 as connectors that can flex/bend and provide relative pivoting between the connected bodies. Flexure joints 112 are thin relative to the bodies they connect and can include one or more holes. Legs 110 can include a first leg 110A connecting to a bottom corner of platform 106 and a second leg 110B connected to an opposite (diagonal) corner of the platform 106. Each leg 110 can include at least one flexure joint 112 that has a smaller cross-sectional area than leg 110, allowing the flexure joint 112 to flex/bend in response to an applied force, while leg 110 remains rigid to provide structural support. Each leg 110 can include a first flexure joint 112 at a first end of the leg 110 where the leg 110 connects to platform 106 and a second flexure joint 112 at a second end of the leg 110 where the leg 110 connects to base 108. Compliant mechanism 104 can include a Chebyschev straight-line linkage configured to convert a non-linear motion into a linear or substantially linear motion, as shown in FIG. 4.

Compliant mechanism 104 includes a translating shuttle 114 coupled to bluff body 102 for moving in a transverse galloping motion when the bluff body 102 is placed in the wind stream and moves. Translating shuttle 114 can be parallel or substantially parallel to platform 106. Translating shuttle 114 can be coupled to bluff body 102 via platform 106. Specifically, translating shuttle 114 can be connected to platform 106 by a flexure joint 112 perpendicular to the translating shuttle 114 and platform 106 and extending from an end of the translating shuttle 114 to a bottom surface of the platform 106. A support 124, with flexure joints 112 on each end of the support 124, can extend between the other end of translating shuttle 114 and one of legs 110 to provide additional support to the translating shuttle 114.

A mechanical to electrical energy conversion mechanism 115 is coupled to compliant mechanism 104 for generating electrical energy in response to movement of translating shuttle 112. Mechanical to electrical energy conversion mechanism 115 can include a magnet 116 attached to translating shuttle 114 and a stationary coil 118 on a coil frame 126 positioned such that movement of the magnet generates a current in the coil 118. Mechanical to electrical energy conversion mechanism 115 can also include a rod 120 attached to magnet 116 and extending from translating shuttle 114 toward coil 118. Rod 120 can include a magnetically-conductive material, such as a metal. In some aspects of the described subject matter, rod 120 can be hollow. Translating shuttle 114 can be positioned to at least partially receive magnet 116 or rod 120. Coil 118 can be supported by a coil base 122. In some aspects of the described subject matter, coil base 122 can be attached to base 108.

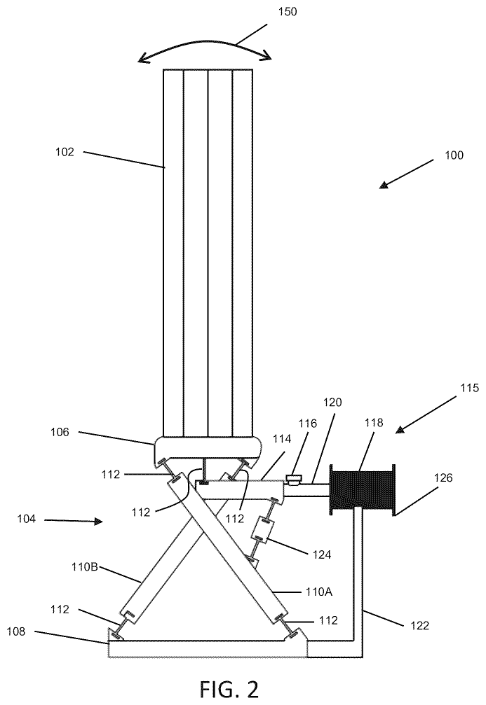

Bluff body 102 creates movement when encountering a wind stream, which causes platform 106 to move. As shown in FIG. 4, bluff body 102 encounters a wind stream in one of the directions as represented by arrows 140. Compliant mechanism 104 restricts movement of bluff body 102 and platform 106 to move in an arc, so the wind stream causes bluff body 102 and platform 106 to move in an arc motion, as represented by arrows 150 shown in FIG. 2, and compliant mechanism moves in a transverse galloping motion. Compliant mechanism 104 converts this non-linear arc motion into a linear or substantially linear motion by translating shuttle 114 as represented by arrows 142. By extension, magnet 116 and/or rod 120 moves in a linear or substantially linear motion. Compliant mechanism 104 can be configured for transverse galloping when encountering wind speeds less than two meters per second.

Bluff body 102, compliant mechanism 104, base 108, and/or coil base 122 can be produced by subtractive manufacturing and/or additive manufacturing, such as 3D printing, as a single unit, which reduces energy loss from friction inherent in an otherwise multi-unit device. In some aspects of the described subject matter, bluff body 102 and compliant mechanism 104 are separate units that are attached together. Bluff body 102 can be removably attached to compliant mechanism 104 for easier manufacturing or transportation of system 100 or to allow a user to replace the bluff body 102 with another bluff body comprising a different shape. System 100, apart from mechanical to electrical energy conversion mechanism 115, can comprise any type of material including, without limitation, wood, metal, alloy, plastic, and/or polymer.

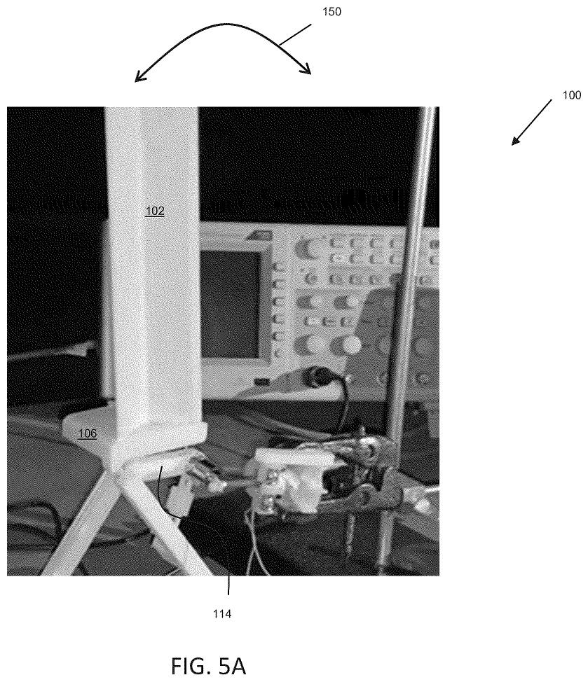

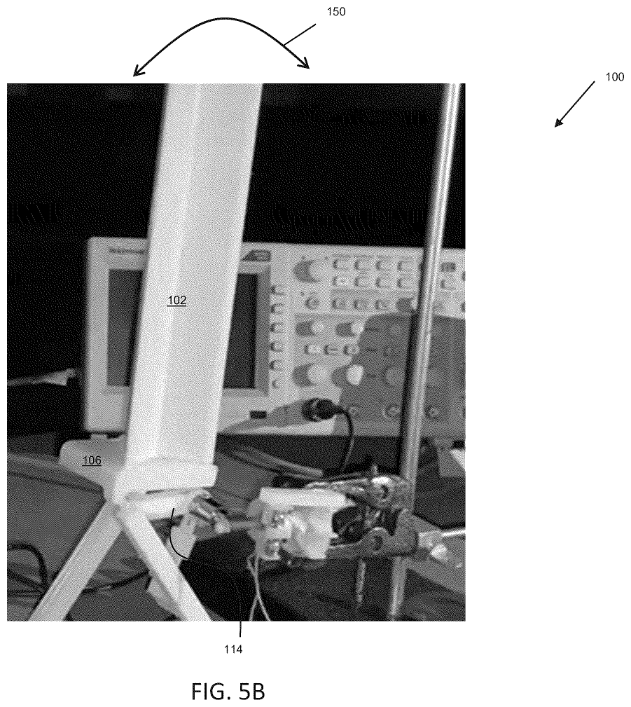

FIGS. 5A and 5B show an example system for harvesting energy from wind flow being moved by a wind stream. FIGS. 5A and 5B show bluff body 102 and compliant mechanism 104 in first and second positions, respectively, of a transverse galloping motion caused by the bluff body's 102 exposure to the wind stream. Bluff body 102 and platform 106 move in an arc motion, as represented by arrows 150. From the first position to second position, translating shuttle 114 is laterally displaced in a linear or substantially linear motion.

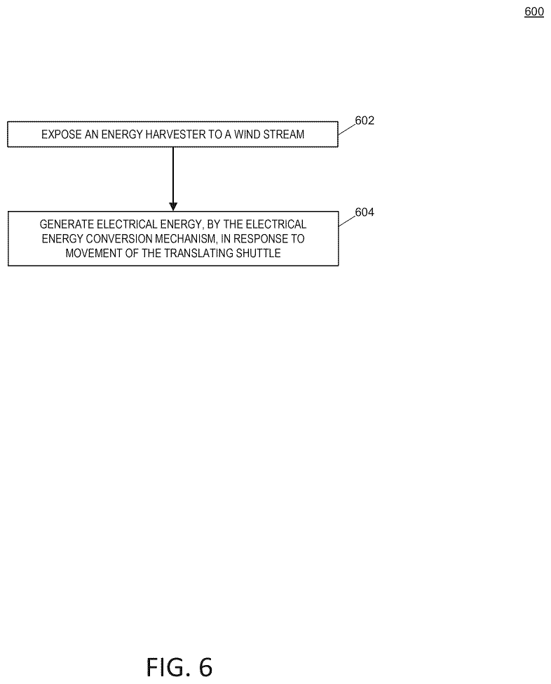

FIG. 6 is a flow chart illustrating an example method 600 for harvesting energy from wind flow. At step 602, an energy harvester is exposed to a wind stream. The energy harvester includes a bluff body comprising an elongate member having a non-circular cross-section. The bluff body is configured for creating movement when placed in a wind stream. The energy harvester further includes a compliant mechanism comprising a translating shuttle coupled to the bluff body for moving in a transverse galloping motion when the bluff body is placed in the wind stream and moves. The energy harvester further includes a mechanical to electrical energy conversion mechanism coupled to the compliant mechanism for generating electrical energy in response to movement of the translating shuttle.

The compliant mechanism can include a Chebyschev straight-line linkage. The compliant mechanism can include a platform attached to the bluff body, a first leg extending from a first end of the platform, and a second leg extending from a second end of the platform opposite the first end, herein the first and second legs each comprise at least one flexure joint. A base can be coupled to the first and second legs. The at least one flexure joint can include a flexure joint on each end of the first and second legs, wherein the platform is coupled to the flexure joints on a first end of the first and second legs, and wherein the base is coupled to the flexure joints on a second end of the first and second legs. The compliant mechanism can be three dimensional (3D) printed. The mechanical to electrical energy conversion mechanism can include a magnet attached to the translating shuttle and a stationary coil positioned such that movement of the magnet generates a current in the stationary coil. The non-circular cross-section of the bluff body can include an arrow shape. The compliant mechanism can be configured for transverse galloping when the bluff body encounters wind speeds less than two meters per second. The compliant mechanism can include a polymer.

At step 604, the electrical energy conversion mechanism generates electrical energy in response to movement of the translating shuttle.

It will be understood that various details of the subject matter described herein may be changed without departing from the scope of the subject matter described herein. Furthermore, the foregoing description is for the purpose of illustration only, and not for the purpose of limitation, as the subject matter described herein is defined by the claims as set forth hereinafter.

What is claimed is:

1. A system for harvesting energy from wind flow, the system comprising:
a bluff body comprising an elongate member having a non-circular cross-section, the bluff body configured for creating movement when placed in a wind stream;
a compliant mechanism comprising a translating shuttle coupled to the bluff body for moving in a transverse galloping motion when the bluff body is placed in the wind stream and moves; and
a mechanical to electrical energy conversion mechanism coupled to the compliant mechanism for generating electrical energy in response to movement of the translating shuttle.

2. The system of claim 1 wherein the compliant mechanism comprises a Chebyschev straight-line linkage.

3. The system of claim 1 wherein the compliant mechanism comprises:
a platform attached to the bluff body;
a first leg extending from a first end of the platform; and
a second leg extending from a second end of the platform opposite the first end;
wherein the first and second legs each comprise at least one flexure joint.

4. The system of claim 3 comprising a base coupled to the first and second legs.

5. The system of claim 4 wherein the at least one flexure joint comprises a flexure joint on each end of the first and second legs, wherein the platform is coupled to the flexure joints on a first end of the first and second legs, and wherein the base is coupled to the flexure joints on a second end of the first and second legs.

6. The system of claim 4 wherein the compliant mechanism is three dimensional (3D) printed.

7. The system of claim 1 wherein the mechanical to electrical energy conversion mechanism comprises a magnet attached to the translating shuttle and a stationary coil positioned such that movement of the magnet generates a current in the stationary coil.

8. The system of claim 1 wherein the non-circular cross-section of the bluff body comprises an arrow shape.

9. The system of claim 1 wherein the compliant mechanism is configured for transverse galloping when the bluff body encounters wind speeds less than two meters per second.

10. The system of claim 1 wherein the compliant mechanism comprises a polymer.

11. A method for harvesting energy from wind flow, the method comprising:
exposing an energy harvester to a wind stream, the energy harvester comprising:
a bluff body comprising an elongate member having a non-circular cross-section, the bluff body configured for creating movement when placed in a wind stream;
a compliant mechanism comprising a translating shuttle coupled to the bluff body for moving in a transverse galloping motion when the bluff body is placed in the wind stream and moves; and
a mechanical to electrical energy conversion mechanism coupled to the compliant mechanism for generating electrical energy in response to movement of the translating shuttle; and
generating electrical energy, by the electrical energy conversion mechanism, in response to movement of the translating shuttle.

12. The method of claim 11 wherein the compliant mechanism comprises a Chebyschev straight-line linkage.

13. The method of claim 11 wherein the compliant mechanism comprises:
a platform attached to the bluff body;
a first leg extending from a first end of the platform; and
a second leg extending from a second end of the platform opposite the first end;
wherein the first and second legs each comprise at least one flexure joint.

14. The method of claim 13 comprising a base coupled to the first and second legs.

15. The method of claim 14 wherein the at least one flexure joint comprises a flexure joint on each end of the first and second legs, wherein the platform is coupled to the flexure joints on a first end of the first and second legs, and wherein the base is coupled to the flexure joints on a second end of the first and second legs.

16. The method of claim 14 wherein the compliant mechanism is three dimensional (3D) printed.

17. The method of claim 11 wherein the mechanical to electrical energy conversion mechanism comprises a magnet attached to the translating shuttle and a stationary coil positioned such that movement of the magnet generates a current in the stationary coil.

18. The method of claim 11 wherein the non-circular cross-section of the bluff body comprises an arrow shape.

19. The method of claim 11 wherein the compliant mechanism is configured for transverse galloping when the bluff body encounters wind speeds less than two meters per second.

20. The method of claim 11 wherein the compliant mechanism comprises a polymer.
